(19) United States
(12) Patent Application Publication
(10) Pub. No.: US 2010/0123317 A1
(43) Pub. Date: May 20, 2010

(54) WIND TURBINE WITH VERTICAL AXIS

(75) Inventors: Mats Leijon, Uppsala (SE); Hans Bernhoff, Uppsala (SE)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: VERTICAL WIND AB

(21) Appl. No.: 12/451,981

(22) PCT Filed: Oct. 6, 2008
(86) PCT No.: PCT/SE2008/050691

§ 371 Date: Dec. 10, 2009

(30) Foreign Application Priority Data
Jun. 11, 2007 (SE) 0701406-1

(51) Int. Cl. F03D 3/00; F03D 11/02

(52) U.S. Cl. 290/55

(57) ABSTRACT

The invention relates to a wind turbine having a vertical turbine shaft (3). According to the invention, the turbine shaft is provided with a joint (13) so that the turbine shaft (3) consists of an upper shaft part (10) and a lower shaft part (11). The invention also relates to a wind-power unit, an electric mains and a use of the wind turbine to generate electrical energy.

### FIELD OF THE INVENTION

The present invention relates in a first aspect to a wind turbine having a vertical turbine shaft and in a second aspect to a wind-power unit.

The invention also relates to an electric mains.

Furthermore, the invention relates to a use of the invented wind turbine.

### BACKGROUND OF THE INVENTION

Recovery of wind energy has been known for thousands of years. To utilize wind power for generation of electric current is also known since long, in principle all the way since the electrical generator saw the light of day.

However, the wind power has had difficulties to successfully compete economically with other energy sources for electrical energy production. The utilization of the wind power for this has for long been limited to local energy supply and test plans. Even if commercial production of wind power-based electrical energy to the mains has developed considerably during the last decades the share thereof of the total electrical energy production is still very marginal.

In view of the great quantity of energy that potentially is available in the wind power and in view of different disadvantages associated with electrical energy production from other types of energy sources, it is important to create opportunities for an increased quantity of commercially competitive production of electrical energy based on wind power.

The predominant technique in generation of electrical energy from wind power units has been based on units where the wind turbine has a horizontal shaft. Different types of wind turbines having vertical shaft have also been proposed. Among these, the Savonius rotor, Darrerius rotor and H-rotor may be mentioned. As an example of the latter kind of rotors for wind power, reference is made to U.S. Pat. No. 6,320,273 and WO 03/058059.

In order to achieve that a wind-power unit should be able to generate electrical energy to competitive prices it is important to optimize each component in such a one from technical and economic point of view.

In a wind turbine with vertical shaft, the turbine shaft is exposed to great stresses, because of the torque that should be transferred from the turbine to the generator as well as influence from bending forces. This makes great demands on the construction and dimensioning of the shaft, which entails high costs.

With the purpose of holding these costs on a reasonable level, it is of course possible to balance on the limits upon the dimensioning. However, it entails risk of operational disturbances and may entail that one is forced to set an upper limit for at which wind force the unit has to be stopped.

In addition, the bending forces are forwarded down to the generator of the wind power unit, which leads to great requirements on bearing mounting of the rotor of the generator and/or risk of inclination of the generator shaft with accompanying operational disturbances.

The present invention has the object to overcome those problems that are related to the mentioned kinds of stresses and thereby provide a turbine shaft, which will be more inexpensive to manufacture but which still enables reliable operation upon high wind forces.

### SUMMARY OF THE INVENTION

The object set forth is attained according to the invention by the fact that the turbine shaft is provided with a joint so that the turbine shaft consists of an upper shaft part and a lower shaft part, the upper shaft part being mounted in at least two radial bearings situated at a distance from each other.

Thanks to this division into two parts by the joint, only the upper part of the shaft will be exposed to bending forces to a full extent. The lower part of the shaft can thereby be dimensioned with lower requirements made from this point of view and thereby be made more inexpensive. The wind turbine will in addition be more reliable in operation by the fact that the bending forces only act fully on the upper shaft part and accordingly to a reduced extent reach down toward the connection of the turbine shaft to the generator of the wind power unit.

By such a bearing mounting of the upper shaft part, a stable carrying of bending forces is provided so that the location for the joint is fixed. This contributes additionally to reducing impact from bending forces on the lower shaft part.

According to a preferred embodiment, the upper shaft part is shorter than the lower shaft part.

Thereby, the part of the turbine shaft that to a reduced extent is exposed to bending forces will be great, which represents that the advantages of the jointed arrangement become relatively considerable.

In that connection, it is preferred that the length of the lower shaft part is 5 to 20 times as large as the length of the lower shaft part.

This is in most cases the optimal balance of the relative lengths of the shaft parts where consideration is given on one hand, to the advantages of making the lower shaft as long as possible and, on the other hand, having sufficient length on the upper shaft to enable a stable bearing mounting of the same.

According to an additional preferred embodiment, the upper shaft part and the lower shaft part have different construction, where the upper shaft part is constructed to be able to carry torque as well as bending moment while the lower shaft part is constructed to in all essentials be able to carry torque and to a smaller extent than the upper shaft part be able to carry bending moment.

Thereby, the possibility of providing a more inexpensive turbine shaft is fully utilized.

According to an additional preferred embodiment, the lower shaft part is via a second joint connected with a generator shaft.

Thereby, the risk is additionally reduced that bending loads are transferred to the generator shaft. The same thereby becomes even more reliable in operation and the bearing mounting can be carried out simpler.

The invention also relates to a wind-power unit provided with a wind turbine according to the invention or some one of the preferred embodiments of the same.

Furthermore, according to the invention, an electric mains is connected to a wind power unit according to the invention.

According to the invented use, the wind turbine is used to generate electrical energy.

The invented wind power plant, the invented electrical mains and the invented method entail the corresponding advantages as have been given above for the invented wind turbine and the preferred embodiments of the same.

The invention is explained in more detail by the subsequent detailed description of advantageous embodiment examples of the same.

### BRIEF DESCRIPTION OF THE FIGURE

FIG. 1 is a vertical section through a wind-power unit provided with a wind turbine according to the invention.

### DESCRIPTION OF ADVANTAGEOUS EMBODIMENT EXAMPLE

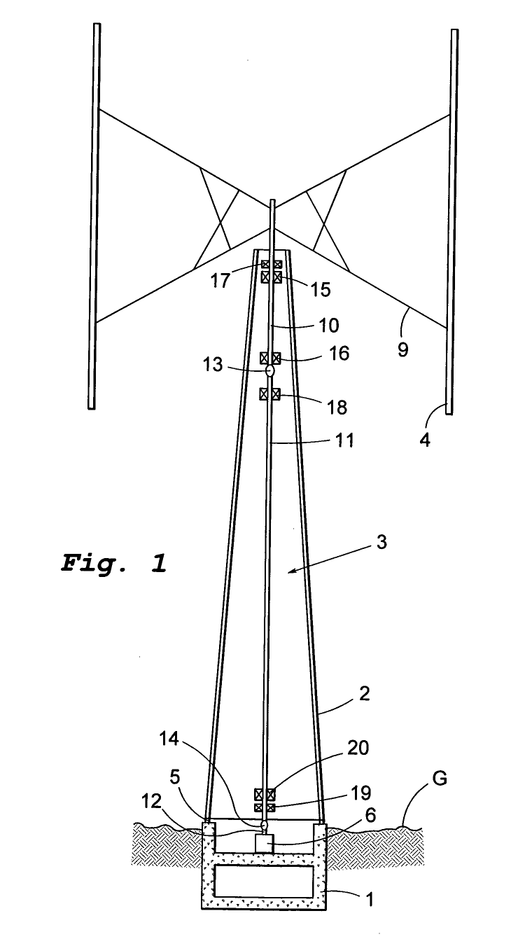

In FIG. 1, a wind turbine according to the invention is illustrated arranged in a wind power unit, which in addition to the wind turbine comprises a foundation 1 and a supporting pillar 2, which rests on the foundation 1 and is anchored at the same by means of anchorage devices 5. Furthermore, a generator 6 is comprised.

The wind turbine has a vertical shaft 3 and a rotor having vertical turbine blades 4. Each turbine blade 4 is connected with the turbine shaft by two supporting arms 9. The shown wind turbine has a so-called H-rotor, but the invention is of course applicable to other types of wind turbines having vertical shafts.

The turbine shaft 3 consists of an upper shaft part 10 and a lower shaft part 11. These two are united by a joint 13, which enables transfer of torque. The joint 13 is suitably a universal joint, for instance a ball-and-socket joint or a cardan joint.

The upper shaft part 10 is considerably shorter than the lower shaft part 11. For a total length of the turbine shaft 3 of 40 m, the length of the upper shaft part 10 is suitably in the order of 5-6 m.

The upper shaft part 10 is mounted in two radial bearings 15, 16, where the upper radial bearing 15 is arranged at the upper end of the supporting pillar 2 and the lower radial bearing at the lower end of the upper shaft part 10 next to the joint 13. Furthermore, there is a thrust bearing 17 arranged to carry the entire or parts of the weight of the wind turbine.

The lower shaft part 11 is preferably but not necessarily radially mounted. The example illustrated in the FIGURE is provided with an upper radial bearing 18 and a lower radial bearing 19. A thrust bearing 20 may also be arranged for the lower shaft part 11.

The lower shaft part 11 is connected with the generator shaft 12. This may be formed as a stiff joint or by the fact that the generator shaft 12 constitutes a direct extension of the lower shaft part 11. However, it may be advantageous, as is shown in the FIGURE, to form also this joint as a joint 14 of universal type.

Both the upper shaft part 10 and the lower shaft part 11 are suitably hollow. The lower shaft part 11 is made having a thinner wall than the upper shaft part 11 since it to a smaller extent needs to carry bending moments. The outer diameter of the respective shaft may also be different for the upper shaft part and the lower shaft part. In the example shown, the lower shaft part 11 has a somewhat greater outer diameter.

1. A wind turbine having a vertical turbine shaft which includes a first joint that divides the turbine shaft into an upper shaft part and a lower shaft part, the upper shaft part being mounted in at least two radial bearings situated at a distance from each other.

2. The wind turbine according to claim 1, wherein the upper shaft part is shorter in length than the lower shaft part.

3. The wind turbine according to claim 2, wherein the length of the lower shaft part is 5 to 20 times as large as the length of the upper shaft part.

4. The wind turbine according to claim 1, wherein the upper shaft part and the lower shaft part have different construction, the upper shaft part being constructed to carry torque as well as bending moment while the lower shaft part is constructed to carry torque and to a smaller extent than the upper shaft part to carry bending moment.

5. The wind turbine according to claim 1, wherein the lower shaft part is connected with a shaft of a generator by a second joint.

6. A wind-power unit which includes a wind turbine according to claim 5.

7. The wind-power unit according to claim 6, wherein the generator is a synchronous generator.

8. The wind-power unit according to claim 6, wherein the generator is permanent magnetized.

9. The wind-power unit according to claim 6, wherein the generator is connected with an AC or DC mains.

10. The wind-power unit according to claim 9, wherein the generator is connected with a 50 or 60 Hz mains via a DC intermediary.

11. An electric mains connected to a wind-power unit according to claim 6.

12. (canceled)
